(19) United States
(12) Patent Application Publication
(10) Pub. No.: US 2006/0133561 A1
(43) Pub. Date: Jun. 22, 2006

(54) System for industrial radiography

(75) Inventors: Gerard M. Droin, Beaune (FR); Nathalie A. Jacquet, Chalon-sur-Saone (FR)

Correspondence Address: Patent Legal Staff;Eastman Kodak Company, 343 State Street, Rochester, NY, 14650-2201, US

(73) Assignee: Eastman Kodak Company

(21) Appl. No.: 11/311,006

(22) Filed: Dec. 16, 2005

(30) Foreign Application Priority Data
Dec. 17, 2004 (FR) 04134401

(51) Int. Cl. G01N 23/00

(52) U.S. Cl. 378/2

(57) ABSTRACT

The present invention relates to a system for industrial radiography comprising: (1) a radiographic element sensitive to X- or γ- radiation comprising a medium of which at least one of the sides is coated with a layer of silver halide emulsion, comprised of tabular grains having an aspect ratio of at least two, and the tabular grains of the silver halide emulsion containing a quantity of iodide more than one percent and lower than three percent in moles, and (2) applied to at least one of the sides of said radiographic element, an intensifying screen that can be a screen emitting electrons, a screen emitting visible light, a screen emitting electrons and visible light and a screen emitting neutrons, said radiographic element being compatible with all said intensifying screens.

### FIELD OF THE INVENTION

The present invention relates to a new system intended for industrial radiography as well as a method of forming a radiographic image.

### BACKGROUND OF THE INVENTION

Industrial radiography is a technique for the nondestructive testing and analysis of defects in parts, such as parts made of glass, paper, wood or metal. This technique is used in many applications in many industries. It is widely used in aeronautics, the nuclear industry, or the oil industry because it enables material welding or texture defects to be detected in the parts of aircraft, nuclear reactors or pipelines. This technique is also used in the construction field (reinforced or prestressed concrete), radiography giving information about the state of the reinforcement and its bending or even the position of ducts and the degree of injection of grout. It is also used in the field of offshore pipelines where the exposure times have to be as short as possible.

This technique consists in exposing a metal part to be analyzed to ionizing radiation, generally X- or γ- rays, with energy between 10,000 kV and 15,000 kV, either directly or by means of an intensifying screen. Therefore with this technique it is necessary to use special radiographic products that are sensitive to this ionizing radiation.

The sensitivity to the X- or γ- rays of radiographic emulsions is due to the absorption of part of these rays by the silver halide grains, which causes a secondary emission of electrons that forms an internal latent image. Consequently, the ionizing rays act on the silver halide grains only when they are absorbed by these grains.

It is known that the major part of the ionizing radiation crosses the silver halide grains without being absorbed. Only a very small part of the incident radiation (less than one percent) is absorbed and contributes to the formation of latent image germs that can be developed.

It is for this reason that products for industrial radiography are generally comprised of a silver halide emulsion including mostly thick grains (three-dimensional or cubic) in order to absorb the maximum of ionizing rays crossing the emulsion layer.

Furthermore, to favor the absorption of ionizing rays, it is known how to increase the silver content, the thickness of the emulsion layers, or to cover the medium of the radiographic product on both sides with a layer of silver halide emulsions.

For some years, we have seen the appearance of silver halide photographic products comprised of tabular grains, which have sensitometric advantages such as, for example, an improved sensitivity/granularity ratio.

In more recent patents, we have thus attempted to introduce these tabular-shaped silver halide grains into products for industrial radiography. For example, U.S. Pat. No. 5,230,993 describes a product for medical or industrial radiography that can contain tabular silver halide grains. However, as the examples show, this patent describes spectrally-sensitized radiographic products, which are intended to be used with fluorescent intensifying screens that re-emit visible light when exposed to X-rays. In this case, the silver halide emulsions are conventional emulsions sensitive to visible light.

Patent EP 0 757 286 describes a system for industrial radiography comprising a radiographic element in which the silver halide emulsion includes tabular silver halide grains having an aspect ratio (diameter to thickness) of at least two, and two metal intensifying screens producing electrons.

Documents of the prior art thus describe products for industrial radiography that are only compatible with one type of intensifying screen.

In practice, manufacturers of products for industrial radiography generally propose various products, each being suited to a specific type of intensifying screen. This means on one hand for the manufacturer to develop and manufacture various products, and on the other hand for the user to order and store various products according to the intensifying screens used. If a radiographic product is not used with the type of intensifying screen that is normally linked to it, the film speed decreases. As a consequence, the quality of the radiographic image also decreases and can become unacceptable for the nondestructive testing of the parts to be examined. Experience has demonstrated that the characteristic curve of films for industrial radiography is practically independent from the energy of the X- or gamma-rays. Films for industrial radiography can be classified in two groups:
films for direct exposure or lead-screen exposure,
films for exposure to fluorescent or fluorometallic screens.

In the first case, the characteristic curve is such that the contrast increases with exposure in the area of useful densities. Contrast of more than one that increases with exposure is in practice of considerable importance. Indeed, amplification of the object contrast by the film enables the smallest details of the internal structure of an object to be revealed. In all industrial radiography, and particularly in the case of very penetrating radiation where the object contrasts are weak, this gain of contrast is sought.

In the case of films for exposure with fluorescent or fluorometallic screens, the contrast increases initially with the exposure before going to a maximum and then decreasing. It is not possible to work at a high density with these films in order to maximize the contrast and visibility of the details of the internal structure.

### SUMMARY OF THE INVENTION

The object of the present invention consists in a new system for industrial radiography that enables the number of photographic products suited to the various types of intensifying screen to be reduced while obtaining a good image quality, whatever the type of intensifying screen is used.

With this object, the present invention relates to a system for industrial radiography comprising:
(1) a radiographic element sensitive to X- or γ- radiation comprising a medium of which at least one of the sides is coated with a layer of silver halide emulsion, where at least 50 percent of the total projected area of grains is represented by tabular grains having an aspect ratio of at least two, and the tabular grains of the silver halide emulsion containing a quantity of iodide more than one percent and lower than three percent in moles, and
(2) applied to at least one of the sides of said radiographic element, an intensifying screen selected from among the group including screens emitting electrons, screens emitting visible light, screens emitting electrons and visible light and screens emitting neutrons, when said radiographic element is exposed to X- or γ- radiation with energy more than or equal to 10 kV, said radiographic element being compatible with all said intensifying screens.

As part of the present invention, “compatible” means that the radiographic system enables a very high image quality to be obtained thus enabling the parts to be examined to be surely tested, whatever the type of intensifying screen used. In particular “compatible” means that the relative speed of the radiographic film used in the system of the present invention is always higher than that of a control radiographic film. In particular, the system according to the present invention produces a characteristic curve such that the contrast increases with exposure in the field of useful densities, i.e. less than five or four, when it is exposed with each of the intensifying screens selected from among the group including screens emitting electrons, screens emitting visible light, screens emitting electrons and visible light and screens emitting neutrons. Thus, whatever type of screen is used, the system according to the present invention enables the smallest details of the structure of the X-rayed object to be revealed.

Other characteristics will appear on reading the following description, with reference to the drawings.

### BRIEF DESCRIPTION OF THE DRAWINGS

FIGS. 1 to 3 represent the characteristic curve of the system according to the invention and the comparative radiographic films exposed with various types of intensifying screens.

### DETAILED DESCRIPTION OF THE INVENTION

As part of the present invention, “tabular grains” means grains having two parallel surfaces wider than the other surfaces of the grain.

The aspect ratio (R) is the ratio of the equivalent circular diameter (ECD) to the average thickness (e) of the grains.

Furthermore, “emulsion comprised of tabular grains” means an emulsion of which at least 50 percent, preferably at least 80 percent, of the grains comprise grains having an aspect ratio more than or equal to two.

Preferably, the tabular grains have an average equivalent circular diameter less than or equal in 2 μm and an average thickness between 0.08 μm and 0.25 μm. The aspect ratio (R) is preferably between 5 and 15.

The tabular grains constituting the emulsion can be monodispersed or polydispersed, preferably monodispersed. Grain monodispersity is defined based on the coefficient of variation (COV), which, expressed as a percentage, equals (σ/ECD)×100 where σ is the standard deviation of the grain population.

The preferred monodispersed emulsions have a COV less than or equal to 25 percent, preferably between 10 percent and 25 percent. According to one embodiment, the COV is between 14 percent and 21 percent. These emulsions with monodispersed tabular grains can be prepared according to the method described in U.S. Pat. No. 5,210,013.

The volume of the grains is measured based on the measurement of the ECD and the thickness of the grains using the formula:
(π(ECD)²/4)×e

the thickness being measured by making a carbon replica of the grain and by measuring the shadow length. This shadow measurement is a conventional measurement that provides an approximation of the grain thickness in order to calculate the volume.

According to a preferred embodiment, the grain volume is between 0.05 μm³ and 2 μm³.

As part of the present invention, the tabular silver halide grains are essentially constituted by silver bromoiodide, i.e. they contain at least 90 percent of silver bromide and a quantity of iodide more than one percent in moles. According to a preferred embodiment, the tabular grains contain a quantity of iodide more than or equal to 1.5 percent in moles.

According to the invention, the tabular grains are essentially constituted by silver bromoiodide containing a quantity of iodide less than three percent in moles.

The tabular grains can also contain chloride.

According to a preferred embodiment, the bromoiodide tabular grains are grains having a peak of iodide, i.e. the iodide is introduced at one time during the precipitation. According to one embodiment, the iodide is introduced when 25 percent to 80 percent of the total silver has been precipitated.

Tabular grains were described for example in Research Disclosure, September 1994, No. 36544, Section I.B (hereafter referred to as Research Disclosure).

The precipitation methods of these tabular grains are known and for example described in Research Disclosure, section C.

The emulsions of the radiographic element of the present invention comprise tabular grains as previously described dispersed in a water permeable hydrophilic colloid such as gelatin, gelatin derivatives, albumin, polyvinylic alcohol, polyvinylic polymers, etc.

Silver halide emulsions can contain dopant agents, generally in small quantities such as ions of rhodium, indium, osmium, iridium etc. (see Section I-D3 of Research Disclosure). These dopants are generally introduced during precipitation of the emulsion.

Silver halide emulsions can be chemically sensitized according to the methods described in the section IV of Research Disclosure. The chemical sensitizers generally used are compounds of sulfur and/or selenium and gold. Reduction sensitizing can also be used.

Silver halide emulsions can contain, among other things, brighteners, anti-foggers, surface actives, plasticizers, lubricants, hardeners, stabilizers, absorption and/or distribution agents such as described in sections II-B, VI, VII, VIII, IX of Research Disclosure.

In addition to the tabular grain emulsion as described previously, the radiographic element can comprise other layers conventional in the radiographic products such as protection layers (overcoat), interlayers, filter layers or antihalation layers. The medium can be any appropriate medium used for industrial radiography products. The conventional media are polymer media such as ethylene polyterephthalate.

Preferably, the medium is covered on its two sides with a silver halide emulsion, at least one of the two emulsions being constituted of tabular grains as previously described. The emulsions located on each side of the medium can be identical or different in size, composition, silver content, etc.

According to a preferred embodiment, the medium is covered on both sides with a layer of silver halide emulsion with tabular grains as previously described. According to the invention, the silver content of the radiographic element is between 50 mg/dm² and 200 mg/dm². This amount can be distributed identically or not between the two sides.

The radiographic element used in the present invention can be hardened using hardeners as described in Research Disclosure, Section II.B. These hardeners can be organic or inorganic hardeners such as chromium salts, aldehydes, N-methylol compounds, dioxane derivatives, compounds comprising active vinyl groups, compounds comprising active halogens, etc.

The system for industrial radiography according to the invention also includes two intensifying screens arranged on either side of the radiographic element as previously defined.

The intensifier screens used in the present invention are of four types:
screens emitting electrons
screens emitting visible light
screens emitting electrons and visible light
screens emitting neutrons

Intensifying screens emitting electrons are generally metal screens which enable the proportion of ionizing rays absorbed by the silver halide grains to be increased. These screens do not emit visible light. The X-rays interact with the intensifying screen by producing electrons in all directions. Part of these electrons will be absorbed by the silver halide grains of the emulsion layer to form latent image sites. By increasing the number of electrons emitted in the direction of the grains, the quantity of electrons absorbed by grains is increased.

Commonly used metal screens have the form of a sheet of lead, lead oxide, or dense metals such as copper or steel. The thickness of these screens is between 0.025 mm and 0.5 mm, and depends on the type of ionizing rays used.

Intensifying screens emitting visible light are fluorescent screens that convert into light part of the X photons not absorbed by the emulsion. Fluorescent screens generally contain particles of phosphor and a binder, preferably comprising a light diffusing material, such as titanium dioxide. Commonly used phosphors are calcium tungstate CaWO₄ and barium sulfate.

Screens emitting electrons and visible light are fluorometallic screens. Fluorometallic screens combine the advantages of lead screens and fluorescent screens. They most often combine a layer of CaWO₄ with a lead screen. They enable a reduction of the exposure while providing an image definition that is clearly better than fluorescent screens. Indeed, lead screens incorporated into fluorometallic screens eliminate diffused radiation liable to produce a fog comparable to background noise. An example of this type of screen is described in U.S. Pat. No. 3,389,255.

Fluorescent screens are used for their intensifying effect when the thicknesses of the parts to be X-rayed are high or when the X-ray generators have limited power. Fluorometallic screens are used in the same cases when a high-definition radiographic image is required. Between 80 kV and 220 kV, fluorometallic screens enable a significant reduction of the fitting times, without affecting the visibility of details compared with lead screens alone.

Screens emitting neutrons are gadolinium screens.

The radiographic image is obtained by exposing to X- or γ- radiation a radiographic element as described above through one of the intensifying screens described above, and by developing the exposed element by conventional treatment processes or by “ecological” treatment processes, e.g. treatment processes in ascorbic acid or hydroquinone-monosulfonate as described in Research Disclosure IPCOM 000008106D.

Treatment processes for industrial radiography generally comprise a black and white development bath containing a developer and a fixing bath comprising a solvent of silver halides such as thiosulfate, thiocyanate, or sulfur organic compounds. Conventional developers are generally dihydroxybenzene, 3-pyrazolidone or aminophenol compounds. In “ecological” treatment processes, the conventional developer is replaced by a more biodegradable compound such as ascorbic acid and/or the auxiliary developer by a more water-soluble derivative as described in Research Disclosure IPCOM 000004576D.

The present invention is illustrated by the following examples which show the advantages of the invention compared with known radiographic systems.

### EXAMPLES

### Example 1

### Radiographic Element Used in the Invention

A silver bromoiodide tabular emulsion (1.5% iodide) was prepared according to the double jet precipitation method by using the accelerated outputs technique.

An aqueous solution of gelatin (approximately 2 g/l) was adjusted to a pH of 5.7, a VAg of −36 mV and warmed to 65° C. The volume was 20 liters.

With continuous stirring, a solution of AgNO₃ (2.7 mole/l) and NaBr (2.7 mole/l) were introduced at the same time in 75 seconds.

After a wait of 60 seconds, a solution of ammonium sulfate (411 g made up to 1 kg) was introduced.

Then the pH was raised to 10.0 and maintained for 150 seconds. The pH was then lowered to 3.5 and maintained for 60 seconds. 560 g of gelatin was added. Then for 60 minutes, a solution of AgNO₃ (2.7 mole/l) and NaBr (2.7 mole/l) at a VAg of −9 mV were introduced by double-jet. The final flow rate was seven times higher than the initial flow rate.

A solution of K₂IrCl₆ (38 mg made up to 1 kg) was introduced in 1 minute, then a solution of KSeCN (27 mg made up to 1 kg) in 2 minutes.

The VAg was then lowered to approximately −45 mV.

An AgI emulsion was then added to produce an AgBrI emulsion with iodide content of 1.5 percent at the end of precipitation.

The VAg was returned to 40 mV.

A last double-jet growth with a solution of AgNO₃ (2.7 mole/l) and NaBr (2.7 mole/l) was performed to finish at a VAg of 50 mV.

The emulsion was then settled or ultrafiltrated.

Tabular grains represented at least 80 percent of the total number of grains making up the emulsion.

Grain tabularity was assessed by the aspect ratio t=ECD/e where ECD is the equivalent circular diameter and e is the grain thickness.

The ECD was about 1.5 μm and the thickness 0.135 μm, the aspect ratio was thus 11.

The emulsion was monodispersed.

The emulsion was chemically sensitized optimally by means of sulfur and gold, the quantity of sulfur being between 30,000 and 50,000 At/μm² and the quantity of gold between 15,000 and 50,000 At/μm² (grain surface area).

The radiographic element used in the system according to the invention was obtained by coating each side of an ESTAR® medium with a layer of said silver bromoiodide tabular emulsion having a silver content of 50 mg/dm² (total silver content 100 mg/dm²).

### Comparative Radiographic Elements

### Examples 2-3

The silver bromoiodide tabular emulsion as described above was reproduced but with an iodide content of one percent (example 2) and of three percent (example 3). A comparative radiographic element was obtained by coating each side of an ESTAR® medium with a layer of said silver bromoiodide tabular emulsion at one percent and three percent iodide having a silver content of 50 mg/dm² (total silver content 100 mg/dm²).

### Examples 4-6

Also used were three other radiographic films available on the market. Their characteristics are given below in Table I:

TABLE I

| | | | Type of | Total silver |
|---|---|---|---|---|
| Examples | Film | Manufacturer | emulsion | content |
| | CX | KODAK | Three- | 150 mg/dm² |
| | | | dimensional | |
| | Structurix D8 | Agfa | Cubic | 190 mg/dm² |
| | Structurix F8 | Agfa | Cubic | 90 mg/dm² |

All the radiographic elements were then placed between two lead screens (27 μm), or two Kyokko SMP 308 fluorometallic screens or two Rennex fluorescent screens, and then exposed to X-rays at voltage 220 kV for the lead screens and at 140 kV for the other screens, and a current of 10 mA.

After exposure, each radiographic element was developed using development servicing, Kodak Industrex Single Part for industrial radiography in a cycle of 8 min., 26° C. and dry-to-dry, which included a development step with a hydroquinone 3-pyrazolidone (100 sec) developer, fixing step, washing step and drying step.

Then the speed of the radiographic elements for a density of 2+D_{medium}+D_{fog} was measured.

The speed was a relative speed calculated from the speed of the comparative example 4 standardized to 100.

The results are given below in Table II.

TABLE II

| | Speed | | |
|---|---|---|---|
| | | | Fluorescent |
| Example | Lead screen | Fluorometallic screen | screen |
| Ex 1 (inv.) | 100 | 130 | 130 |
| Ex 2 (comp.) | 100 | 70 | 90 |
| Ex 3 (comp.) | 90 | 130 | — |
| Ex 4 (comp) | 100 | 100 | 100 |
| Ex 5 (comp.) | 100 | 80 | 80 |
| Ex 6 (comp.) | 70 | 130 | 130 |

Example 2 showed that the emulsion containing tabular grains but with an iodide content of one percent did not enable a radiographic system to be obtained in which the radiographic element would be compatible with all types of intensifying screens because the speed is only 70 with the fluorometallic screen, and 90 with the fluorescent screen, compared with a speed of 130 with the system according to the invention. As a consequence, an iodide content less than or equal to one percent decreased the speed.

Example 3 showed that the emulsion containing tabular grains but with an iodide content of three percent did not enable a radiographic system to be obtained in which the radiographic element would be compatible with all types of intensifying screens because the speed is only 90 with the lead screen, compared with a speed of 100 with the system according to the invention. Furthermore, even if Example 3 showed a speed of 130 with the fluorometallic screen, a significant loss in contrast was observed at the same time. Indeed, the contrast obtained for Example 1 with the fluorometallic screen was 3.3 while it was 2.2 for Example 3 with the fluorometallic screen. As a consequence, an iodide content more than or equal to three percent caused a loss of contrast.

Comparative Examples 5 and 6 showed that these radiographic films available on the market did not enable a radiographic system to be obtained in which the radiographic element would be compatible with all types of intensifying screens because for Example 5, the speed is only 80 with fluorescent and fluorometallic screens compared with a speed of 130 with the system according to the invention, and for Example 6, the speed is only 70 with the lead screen compared with a speed of 100 with the system according to the invention.

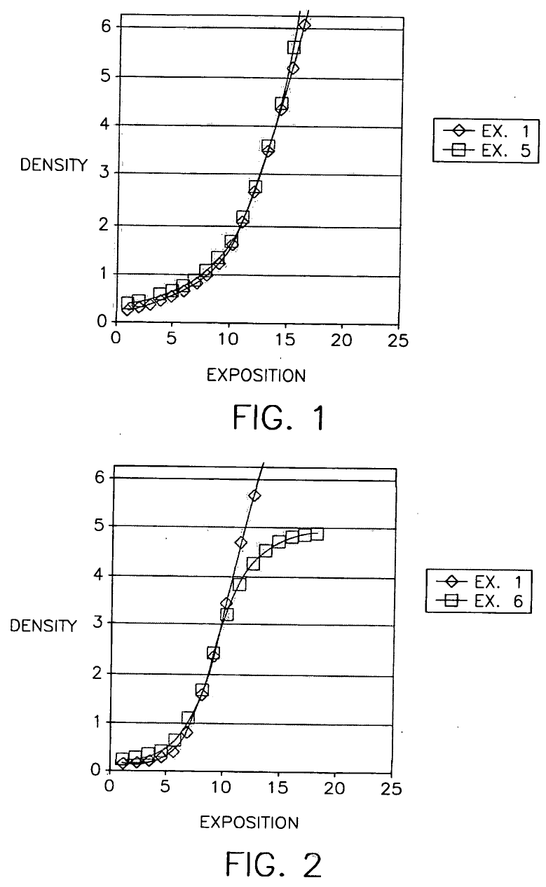

FIG. 1 shows the characteristic curve of Examples 1 and 5 exposed with two lead screens. The curve shows the density according to the exposure.

The contrast is the slope of the least squares line between density point 1.5 and density point 3.5.

The characteristic curves are linear in both cases.

FIG. 2 shows the characteristic curve of Examples 1 and 6 exposed with two Kyokko SMP 308 fluorometallic screens. Example 1 according to the invention has a linear characteristic curve with contrast that increases even when the density is more than four whereas Example 6 has a Dmax and contrast that decreases in the zone of densities more than four.

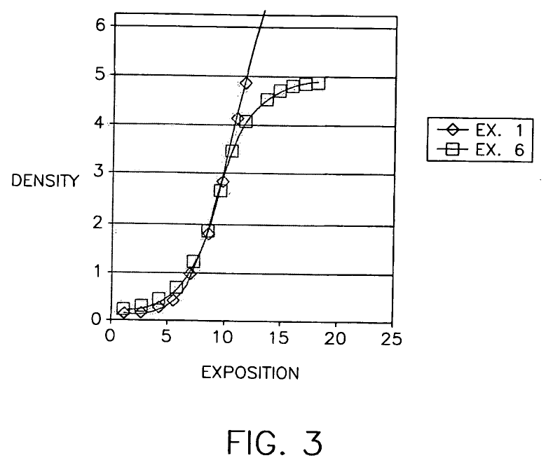

FIG. 3 shows the characteristic curve of Examples 1 and 6 exposed with two Rennex fluorescent screens. Example 1 according to the invention has a linear characteristic curve with contrast that increases even when the density is more than four whereas Example 6 has a Dmax and contrast that decreases in the zone of densities more than four.

Thus, only the system according to the present invention produces a characteristic curve such that the contrast increases with exposure in the field of useful densities, when it is exposed with each of the types of intensifying screens.

As a consequence, the comparative examples below clearly show that only the radiographic system according to the invention enables no loss of speed and contrast by changing the type of intensifying screen. The system according to the present invention, using a single type of radiographic element, advantageously enables the replacement of the two films of comparative Examples 5 and 6.

1. System for industrial radiography comprising:
(1) a radiographic element sensitive to X- or γ- radiation comprising a medium of which at least one of the sides is coated with a layer of silver halide emulsion, where at least 50 percent of the total projected area of grains is represented by tabular grains having an aspect ratio of at least two, and the tabular grains of the silver halide emulsion containing a quantity of iodide more than one percent and lower than three percent in moles, and
(2) applied to at least one of the sides of said radiographic element, an intensifying screen selected from among the group including screens emitting electrons, screens emitting visible light, screens emitting electrons and visible light and screens emitting neutrons, when said radiographic element is exposed to X- or γ- radiation with energy more than or equal to 10 kV, said radiographic element being compatible with all said intensifying screens.

2. A system according to claim 1, wherein the tabular grains of the silver halide emulsion contain a quantity of iodide equal to 1.5 percent in moles.

3. A system according to claim 1, wherein the tabular grains of the silver halide emulsion comprise silver bromoiodide.

4. A system according to claim 3, wherein the tabular grains of the silver bromoiodide emulsion have an average equivalent circular diameter less than or equal to 2 μm and an average thickness between 0.08 μm and 0.25 μm.

5. A system according to claim 1, wherein the silver content of the radiographic element is between 50 mg/dm² and 200 mg/dm².

6. A system according to claim 1, characterized in that it produces a characteristic curve such that the contrast increases with exposure in the field of useful densities, when it is exposed with each of the intensifying screens selected from among the group including screens emitting electrons, screens emitting visible light, screens emitting electrons and visible light and screens emitting neutrons to X- or γ- radiation with energy more than or equal to 10 kV.

7. A method of forming an industrial radiographic image which consists in exposing a system as defined in any one of claims 1 to 6 to X- or γ- radiation, with energy more than or equal to 10 kV, to form a latent image, and to develop the radiographic element.
